(19) United States
(12) Patent Application Publication
(10) Pub. No.: US 2006/0293950 A1
(43) Pub. Date: Dec. 28, 2006

(54) Automatic ad placement

(75) Inventors: Christopher A. Meek, Kirkland, WA (US); David Earl Heckerman, Bellevue, WA (US); David Maxwell Chickering, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/168,149

(22) Filed: Jun. 28, 2005

(51) Int. Cl. G06Q 30/00

(52) U.S. Cl. 705/14

(57) ABSTRACT

A computer-implemented method is provided for controlling placement of ad impressions, corresponding to ads, displayed on a web page. The method includes recording features corresponding to ad impressions. Recording features can include collecting sufficient statistics for a Naïve Bayes model in some embodiments. A statistical algorithm is then used to automatically control placement of ad impressions.

### BACKGROUND

The discussion below is merely provided for general background information and is not intended to be used as an aid in determining the scope of the claimed subject matter.

Searching and choosing products and services through computer-based search engines has become increasingly prolific in recent years. As such, content providers, i.e., those companies and/or individuals desiring content specific to their product(s) or service(s) to be displayed as a result of a given search engine query, e.g., advertisers, have begun to understand the value that placement of content items, e.g., descriptors or advertisements of their products or services, as a result of a search engine query can have on their sales.

Existing online ad serving systems typically require the advertiser to determine where and when to present their ads. Advertisers then get reports about features of the presentation which were most favorable (e.g., when users clicked the most on the ad, what demographics were most correlated with clicks, what keyword was searched) and modify the placement of their ad accordingly. This process can be relatively lengthy and time consuming. Further, it is an important process for a number of reasons. One such reason is that the amount that advertisers pay for presentation of their ads can be a function of placement position, frequency, and other parameters, and if ad placement isn't carefully chosen, then the advertiser may not get the best value for their advertising expenditures.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

To aid in controlling placement of ad impressions displayed on a web page, a method is provided. Using one embodiment of the method, features corresponding to each of multiple clicked on ad impressions are recorded. Also, features for a random sample of ad impressions are recorded. A statistical algorithm is used to identify which features, of the recorded features, are most predictive of click through rates. The method also includes automatically controlling placement of ad impressions based upon the features identified to be the most predictive of the click through rates.

In another embodiment, the method includes collecting sufficient statistics for a Naïe Bayes model for each of multiple ad impressions. A first portion of the multiple ad impressions having been clicked on, and a second portion of the multiple ad impressions having not been clicked on. A Naïe Bayes model is used, with the collected sufficient statistics for the Naïe Bayes model, to predict click through rates for ad impressions corresponding to ads. This embodiment of the method also includes automatically controlling placement of ad impressions based on the predicted click through rates.

### BRIEF DESCRIPTION OF THE DRAWINGS

FIG. 1 is a block diagram of a general computing environment in which disclosed concepts can be practiced.

FIG. 2 is a block diagram of a computing environment, illustrating disclosed features and concepts.

FIG. 3-1 is a flow diagram illustrating a first method embodiment.

FIGS. 3-2 and 3-3 illustrate more particular embodiments of steps of the flow diagram shown in FIG. 3-1.

FIG. 4-1 is a flow diagram illustrating a second method embodiment.

FIGS. 4-2 through 4-5 illustrate more particular embodiments of steps of the flow diagram shown in FIG. 4-1.

### DETAILED DESCRIPTION

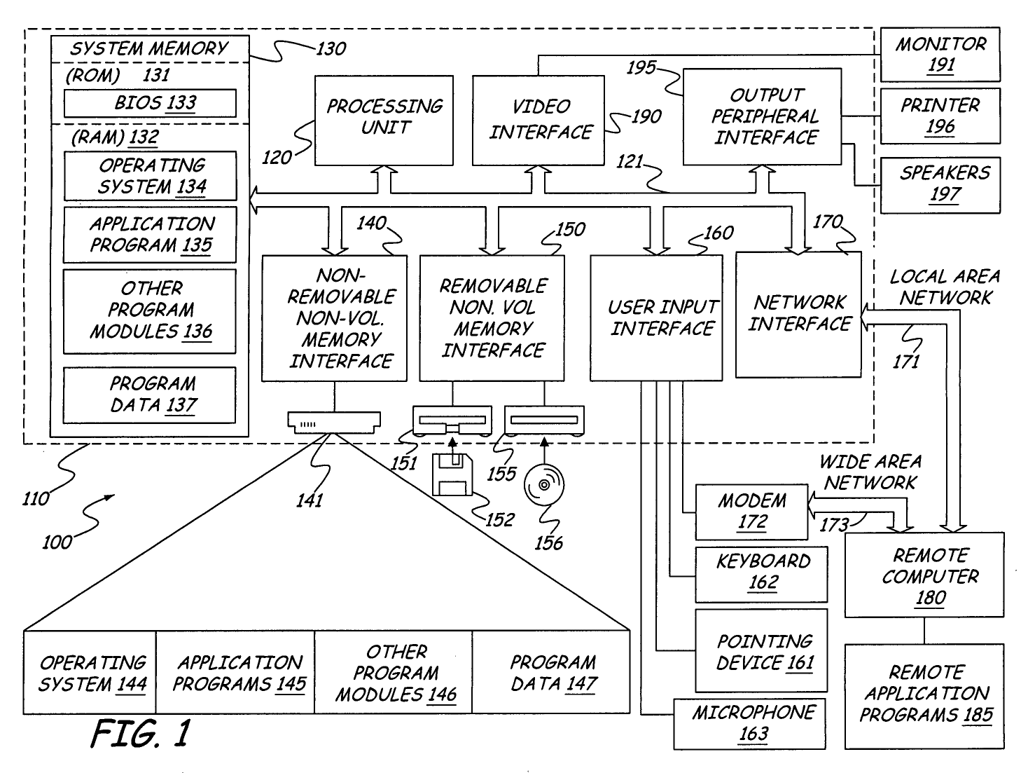

Disclosed embodiments include methods, apparatus and systems which automatically improve placement of ads on pages, such as web pages. The methods, apparatus and systems can be embodied in a variety of computing environments, including personal computers, server computers, etc. Before describing the embodiments in greater detail, a discussion of an example computing environment in which the embodiments can be implemented may be useful. FIG. 1 illustrates one such computing environment.

FIG. 1 illustrates an example of a suitable computing system environment 100 on which one or more aspects of the illustrated embodiments may be implemented. The computing system environment 100 is only one example of a suitable computing environment and is not intended to suggest any limitation as to the scope of use or functionality of the illustrated embodiments. Neither should the computing environment 100 be interpreted as having any dependency or requirement relating to any one or combination of components illustrated in the exemplary operating environment 100.

The illustrated embodiments are operational with numerous other general purpose or special purpose computing system environments or configurations. Examples of well-known computing systems, environments, and/or configurations that may be suitable for use with the illustrated embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The illustrated embodiments may be described in the general context of computer-executable instructions, such as program modules, being executed by a computer. Generally, program modules include routines, programs, objects, components, data structures, etc. that perform particular tasks or implement particular abstract data types. The illustrated embodiments may also be practiced in distributed computing environments where tasks are performed by remote processing devices that are linked through a communication network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 1, an exemplary system includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

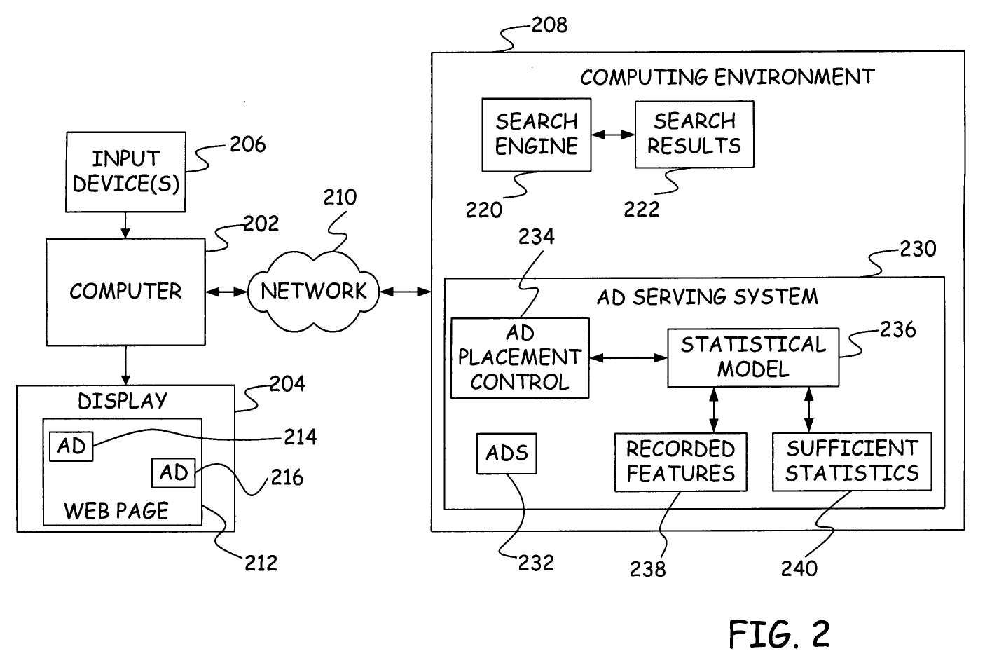

Referring now to FIG. 2, shown are other environments in which disclosed embodiments can be implemented. As illustrated in FIG. 2, a computer 202 includes a display device 204 and one or more input devices 206. A user of the computer 202 can access web pages 212 from a server computer or computing environment 208 via a network connection 210, for example an Internet connection. A web page 212 is depicted in FIG. 2 as being displayed on device 204. As is typical, advertisements (ads) 214 and 216 are also displayed or rendered on the web page 212. One example of a web page on which ads are typically rendered is a search engine web page, from a search engine 220. In response to query terms, phrases, etc., search engine 220 returns search results 222 to the user of computer 202 via web page 212. With the use of an ad serving system 230, some of ads 232 handled by system 230 are rendered on web page 212 along with the search results. In the illustrated example, the rendered ads are ads 214 and 216.

Placement of ads on web pages such as page 212 is controlled by ad placement control module or component 234 of system 230. In disclosed embodiments, instead of controlling ad placement based on analysis by the companies or persons placing the ads, ad placement control 234 controls ad placement using a statistical model 236. Depending on the statistical model used, the statistical analysis can be based on recorded features 238 or sufficient statistics (for a Naïe Bayes model) 240, both of which are described below in greater detail.

FIGS. 3-1 and 4-1 are flow diagrams illustrating methods implemented in a computing environment such as the one shown in FIG. 2. These methods can be implemented, for example, in components of ad serving system 230. For example, these methods can be implemented in ad placement control module 234 and statistical model 236. The computing environments shown in FIGS. 1 and 2 should be considered to be configured or programmed to implement methods such as those shown in FIGS. 3-1 and 4-1, as well as in the optional more particular step embodiments illustrated in FIGS. 3-2, 3-3, and 4-2 through 4-5.

In some embodiments, each time an ad is clicked (i.e., using input devices 206), the online ad serving system 230 records potentially relevant features 238 of the ad impression. Examples of potentially relevant features include the time the ad impression was served, the demographics (age, gender, occupation, etc.) of the user who clicked on the ad, what keyword or phrase the user typed in, etc. An ad impression is an displayed or rendered ad, or the act of displaying the ad. Also, for a sample of impressions (e.g., a small random sample), the same or corresponding features are recorded. This sample of impressions includes ads that were not clicked on. Then, at regular intervals (e.g., once every day) and for each ad, a statistical algorithm (statistical model 236) is used to find those features 238 that are predictive of click through or click through rates. Ads are then automatically shown by ad placement control 234, preferentially at times and to users that will likely produce more clicks.

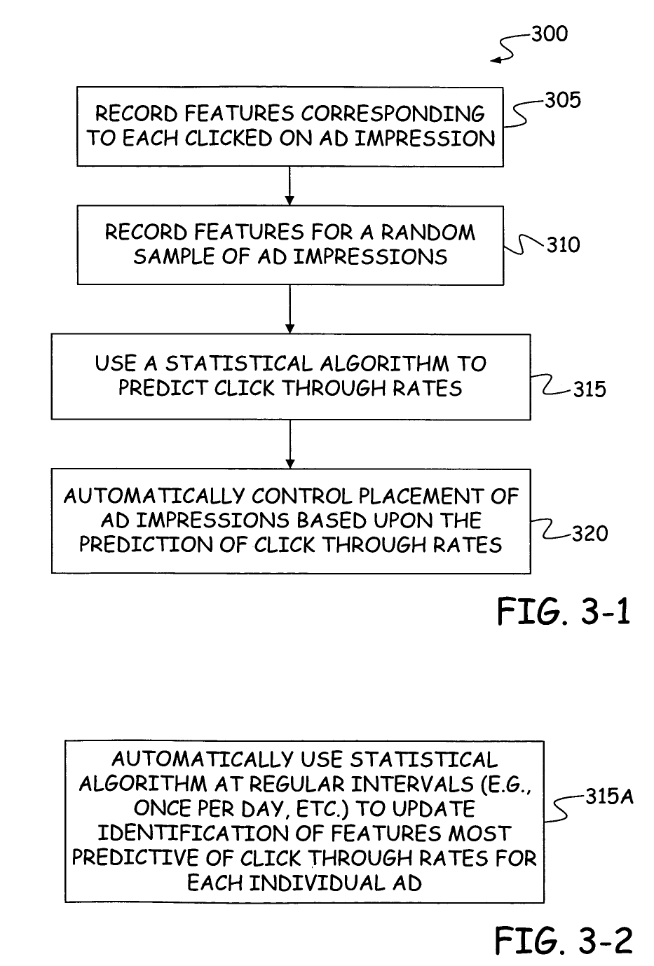

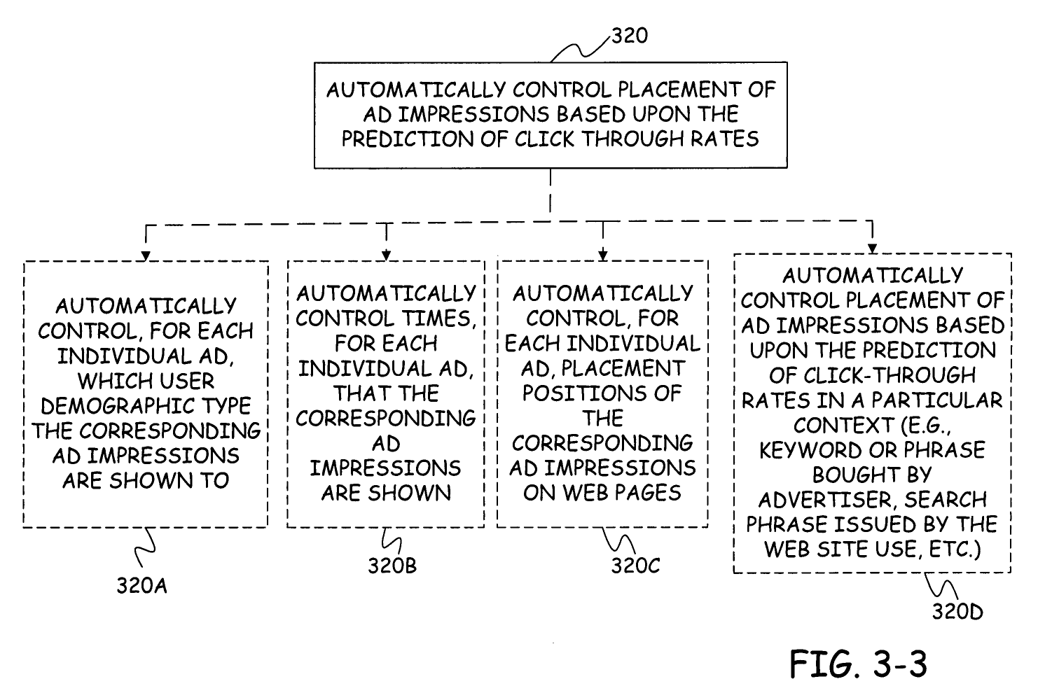

The flow diagram 300 shown in FIG. 3-1 illustrates this in greater detail. As illustrated at block 305, a disclosed method for controlling placement of ad impressions, displayed on a web page, includes the step of recording features corresponding to each of a plurality of clicked on ad impressions. Also, as illustrated at block 310, the method includes the step of recording features for a random sample of ad impressions. As described above, this random sample of ad impressions will include some that were not clicked on.

Next, as shown at block 315, the method includes using a statistical algorithm or model to predict click through rates. This can be done for each individual ad. A wide variety of statistical algorithms can be used in various embodiments, with one specific embodiment using a Naïve Bayes model based statistical algorithm. However, embodiments are not limited to a specific statistical algorithm. For example, other examples of statistical algorithms include logical regression based statistical algorithms, decision tree based statistical algorithms, and neural network based statistical algorithms. As shown at block 315A in FIG. 3-2, in a more particular and optional embodiment, this step includes automatically using the statistical algorithm at regular intervals (e.g., once per day, etc.) to update identification of features which are most predictive of click through rates for each individual ad.

Then, as shown at block 320, the method includes automatically controlling placement of ad impressions based upon the predictions from the statistical algorithm. More particular and optional embodiments of this step are shown at blocks 320A through 320D in FIG. 3-3. Automatically controlling placement of ad impressions based on the identified features can include, for example, controlling which user demographic type the corresponding ad impressions are shown to (320A), controlling times that the corresponding ad impressions are shown (320B), controlling which keywords entered by the user will result in an ad impression being selected for a user, and controlling, placement positions of the corresponding ad impressions on web pages (320C). In another embodiment shown at 320D, step 320 includes automatically controlling placement of ad impressions based on the prediction of click-through rates in a particular context (e.g., keyword or phrase bought by advertiser, search phrase issued by the web site use, etc.). By providing this statistical analysis automatically and at regular intervals (e.g., at least once a day, at least once a week, etc.) or on a routine basis, and by automatically controlling ad placement based on the results of the statistical analysis, the ad placement process can be significantly more efficient and beneficial for the companies or persons placing the ads.

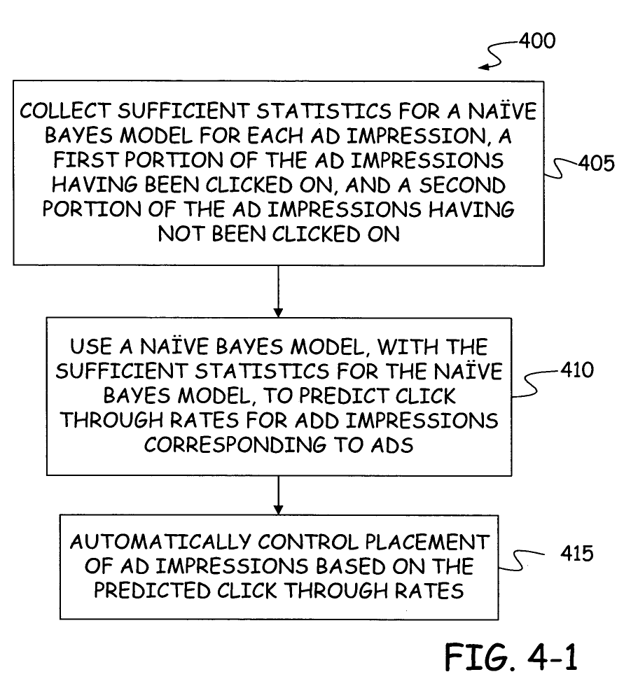

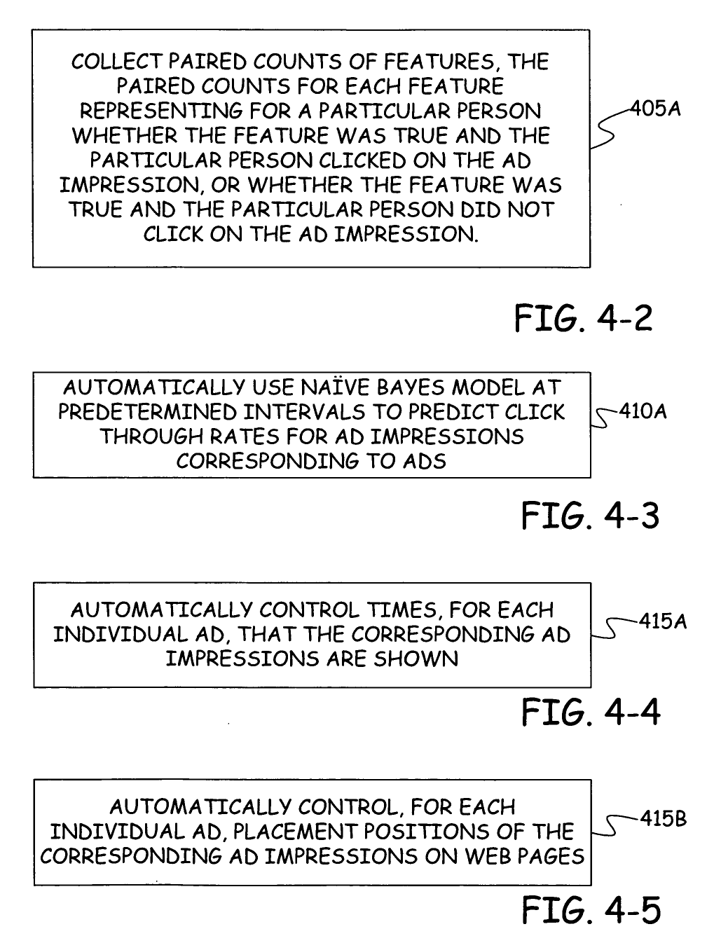

In some embodiments, statistical model 236 is a Naïe Bayes model, and the collected features are Naïe Bayes model inputs. Specifically, the collected features or data are in the form of what known as “sufficient statistics for a Naïe Bayes model”. In these embodiments, which are also illustrated in FIG. 4-1, ad serving system 230 collects sufficient statistics for a Naïe Bayes model for every impression.

Sufficient statistics for a Naïe Bayes model are counts of the instances that match certain criteria (e.g., attribute-value-class counts). For example, consider an embodiment in which one of the features is whether the person is young or not. In this case, a sufficient statistic would be whether the person is young and clicked, and another sufficient statistic would be whether the person was young and didn't click. Sufficient statistics only have to be stored in these paired counts for the Naïve Bayes model. In the context of disclosed embodiments, sufficient statistics relating to a particular feature will often be “Did the person click and is the feature true?” and “Did the person not click and is the feature true.”

All sufficient statistics in the Naïe Bayes model can be discrete or discretized. Using the age features example collecting sufficient statistics could include getting counts on “Is the person young and they did click”, and “Is the person young and they didn't click”. The next feature might be “Is the person middle aged and they did click”, and “Is the person middle aged and they didn't click.” Thus, for any feature, with a feature being a variable, its value is divided into two or more discrete states. In the case of the age feature, the states could be “young,” “middle aged” and “old.” In the case of gender, the discrete states are “male” and “female.” For time of day, example states might be defined to be “morning”, “around lunch”, “afternoon”, “evening” and “late night” (i.e., discrete ranges of time). Generally, a feature is a collection of discrete events that cover all of the possibilities for the feature. Once the sufficient statistics are collected, a Naïve Bayes model can be trained or built such that it predicts whether a person is going to click or not. Its possible to have a continuous feature such as age; if a Gaussian distribution is used for p(age|click), then the sufficient statistics are Gaussian sufficient statistics for both click and non-click. The Gaussian sufficient statistics are: the total count, the sum of the variable values (e.g. sum of ages) and the sum of the squares of the variable values.

A method of controlling placement of ad impressions using a Naïe Base model is first provided with reference to the flow diagram of FIG. 4-1. Then, a general description of a Naïe Bayes model of predicting click through rates (CTRs) is provided.

As shown in flow diagram 400 shown in FIG. 4-1, a method is provided for controlling placement of ad impressions, corresponding to ads, displayed on a webpage. At block 405, the method is shown to include the step of collecting sufficient statistics for a Naïe Bayes model for each of a plurality of ad impressions. A first portion of the plurality of ad impressions has been clicked on, and a second portion of the plurality of ad impressions has not been clicked on. In a more particular and optional embodiment illustrated at 405A in FIG. 4-2, this step includes collecting paired counts of features. The paired counts for each feature representing for a particular person shown an ad impression whether the feature was true and the particular person clicked on the ad impression, or whether the feature was true and the particular person did not click on the ad impression.

Then, as illustrated at block 410, the method includes the step of using a Naïe Bayes model, with the collected sufficient statistics, to predict click through rates for ad impressions corresponding to ads. In a more particular and optional embodiment illustrated at 410A in FIG. 4-3, this step includes automatically using the Naïe Bayes model at predetermined intervals. Then, as shown at block 415, the method includes automatically controlling placement of ad impressions based on the predicted click through rates. In a more particular and optional embodiment illustrated at 415A in FIG. 4-4, this step includes automatically controlling times, for each individual ad, that the corresponding ad impressions are shown. In a more particular and optional embodiment illustrated at 415B in FIG. 4-5, this step includes automatically controlling, for each individual ad, placement positions of the corresponding ad impressions on web pages.

As described above, the step of collecting the sufficient statistics for the Naïe Bayes model includes collecting paired counts for a plurality of features, the paired counts for each feature representing for a particular person clicking on an ad impression whether the feature was true and the particular person clicked on the ad impression, or whether the feature was true and the particular person did not click on the ad impression.

Estimating Click-through rates using a Naïe Bayes Model

Given these sufficient statistics and N, the total number of observations, count(click), the total number of observed clicks, and count(not click), the total number of observed non-clicks, the Naïe-Bayes model specifies the probability of click through given a set of features f₁, . . . fₙ as follows:.

$$p ( click \text{\vert} {f}_{1} , … , {f}_{n} ) = \frac{p ( click ) {\prod }_{i = 1}^{n} p ( {f}_{i} \text{\vert} click )}{p ( click ) {\prod }_{i = 1}^{n} p ( {f}_{i} \text{\vert} click ) + p ( not click ) {\prod }_{i = 1}^{n} p ( {f}_{i} \text{\vert} not click )}$$

where

p(click)=count(click)/N

p(not click)=count(not click)/N

and

p(fᵢ\click)=count(fᵢ,click)/count(click)

p(fᵢ\not click)=count(fᵢ,not click)/count(not click)

Those practiced in the art will recognize that priors in the form of hypothetical observed counts can be added to the sufficient statistics before the computations above are performed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for controlling placement of ad impressions, corresponding to ads, displayed on a web page, the method comprising:
recording features corresponding to each of a plurality of clicked on ad impressions;
recording features for a random sample of ad impressions;
using a statistical algorithm to predict click through rates; and
automatically controlling placement of ad impressions based upon the prediction of click-through rates.

2. The computer-implemented method of claim 1, wherein using the statistical algorithm to predict click through rates further comprises:
automatically using the statistical algorithm at regular intervals to update the identification of which features are most predictive of click through rates.

3. The computer-implemented method of claim 2, wherein automatically using the statistical algorithm at regular intervals further comprises:
automatically using the statistical algorithm at least once a day to update the identification of which features are most predictive of click through rates.

4. The computer-implemented method of claim 2, wherein using the statistical algorithm predict click through rates further comprises:
using the statistical algorithm to identify click through rates for each individual ad.

5. The computer-implemented method of claim 4, wherein automatically controlling placement of ad impressions further comprises:
automatically controlling, for each individual ad, which user demographic type the corresponding ad impressions are shown to.

6. The computer-implemented method of claim 4, wherein automatically controlling placement of ad impressions further comprises:
automatically controlling times, for each individual ad, that the corresponding ad impressions are shown.

7. The computer-implemented method of claim 4, wherein automatically controlling placement of ad impressions further comprises:
automatically controlling, for each individual ad, placement positions of the corresponding ad impressions on web pages.

8. The computer-implemented method of claim 1, wherein automatically controlling placement of ad impressions further comprises:
automatically controlling placement of ad impressions based upon the prediction of click-through rates in a particular context.

9. The computer-implemented method of claim 8, wherein the particular context includes a keyword or phrase bought by an advertiser.

10. The computer-implemented method of claim 8, wherein the particular context includes a search phrase issued by the web site user.

11. A computer-readable medium containing computer-executable instructions for implementing the steps of claim 1.

12. An ad serving system configured to execute computer-executable instructions for implementing the steps of claim 1.

13. A computer-implemented method for controlling placement of ad impressions, corresponding to ads, displayed on a web page, the method comprising:
collecting sufficient statistics for a Naïe Bayes model for each of a plurality of ad impressions, a first portion of the plurality of ad impressions having been clicked on, and a second portion of the plurality of ad impressions having not been clicked on;
using a Naïe Bayes model, with the sufficient statistics for the Naïe Bayes model, to predict click through rates for ad impressions corresponding to ads;
automatically controlling placement of ad impressions based on the predicted click through rates.

14. The computer-implemented method of claim 13, wherein collecting the sufficient statistics for the Naïe Bayes model further comprises collecting paired counts for a plurality of features, the paired counts for each feature representing for a particular person whether the feature was true and the particular person clicked on the ad impression, or whether the feature was true and the particular person did not click on the ad impression.

15. The computer-implemented method of claim 14, wherein each of the plurality of features has discrete values.

16. The computer-implemented method of claim 13, wherein using the Naïe Bayes model to predict click through rates for ad impressions corresponding to ads further comprises:
automatically using the Naïe Bayes model at predetermined intervals to predict click through rates for ad impressions corresponding to ads.

17. The computer-implemented method of claim 16, wherein automatically controlling placement of ad impressions based on the predicted click through rates further comprises:
automatically controlling times, for each individual ad, that the corresponding ad impressions are shown.

18. The computer-implemented method of claim 16, wherein automatically controlling placement of ad impressions based on the predicted click through rates further comprises:
automatically controlling, for each individual ad, placement positions of the corresponding ad impressions on web pages.

19. A computer-readable medium containing computer-executable instructions for implementing the steps of claim 13.

20. An ad serving system configured to execute computer-executable instructions for implementing the steps of claim 13.
